(19) United States
(12) Patent Application Publication
(10) Pub. No.: US 2017/0334594 A1
(43) Pub. Date: Nov. 23, 2017

(54) LABEL APPLICATOR PAD

(71) Applicant: NuLabel Technologies, Inc., East Providence, RI (US)

(72) Inventors: Michael Clarke Woods, Rumford, RI (US); Randy Peckham, North Scituate, RI (US); Jason A. Meek, Pawtucket, RI (US); Andrew W. Marsella, Providence, RI (US)

(73) Assignee: NuLabel Technologies, Inc., East Providence, RI (US)

(21) Appl. No.: 15/159,380

(22) Filed: May 19, 2016

(51) Int. Cl. B65C 9/00

(52) U.S. Cl. CPC B65C 9/00

(57) ABSTRACT

A label applicator pad is included in a labeling system to press a label against the surface of an article. According to some aspects, a label applicator pad includes a pad body having a support portion and a contact portion having a textured working surface. The support may have a compliance that is higher than a compliance of the contact portion. According to other aspects, the textured working surface may have a contact area that physically contacts a label and a void portion adjacent the contact portion, and the void portion does not contact the label. The textured working area may include contact portion having a contact area that is less than a total area of the working area.

### BACKGROUND

### 1. Field

Aspects described herein relate generally to label applicator pads for use in automated labeling systems.

### 2. Discussion of Related Art

Automated machines are often used to apply labels onto articles or containers such as bottles, cans or jars. Typically these machines utilize cold glue or hot melt adhesives which are applied by a roller onto a pad prior to picking up and transferring of a label onto another pad or drum which applies it to a container. Conventional automated labeling machines include those manufactured by Krones AG in Germany or Krones, Inc. in Franklin Wis. (Krones AG and Krones, Inc., being referred to herein as “Krones”). Although these adhesives are useful for their intended purpose, it has been found that applying tacky liquid adhesives prior to pickup of labels and throughout the entire label application process is undesirable as the liquid adhesives contact various parts of the machine creating a mess, and can require excessive maintenance including machine downtime for cleaning. In addition to cold and hot glue labeling methods, preprinted pressure sensitive adhesive (PSA) labels are also used. These labels utilize a release liner to protect the preprinted label face from interacting with the tacky PSA. The use of traditional PSA labels results in several million pounds of waste per year in the bottling industry. PSAs also lack removability properties desirable in downstream recycling and bottle reusing facilities.

Recently, labeling systems using fluid activatable adhesives have been developed. A label having a fluid activatable adhesive on one side is non-tacky until just prior to the application of the label to the article. Upon application of an activating fluid to activate the adhesive, the fluid activatable adhesive becomes tacky and the label can be pressed against an article or a container to apply the label thereto. Accordingly, labeling systems utilizing fluid activatable adhesives can avoid the above-noted drawbacks associated with typical tacky adhesives (i.e., cold glue and hot melt adhesives) and PSA labels.

### SUMMARY

The inventors have appreciated that conventional label applicator pads, which are used in automated labeling systems to forcibly press a label against the surface of an article, can have numerous drawbacks, many of which are exacerbated when used with labels having fluid activatable adhesives. For example, in some cases, a tackiness of a fluid activatable adhesive immediately after activation may be less than that of a typical adhesive. Thus, a higher application force may be needed to apply a label having a fluid activatable adhesive to an article compared to the force required when using conventional tacky adhesives. However, the inventors have appreciated that conventional label applicator pads are not well suited to apply these higher forces. In particular, conventional label applicator pads are typically made from compliant foam materials which, in some cases, are not capable of applying the higher application forces and/or may exhibit a much shorter wear-life, and thus require frequent replacement, when operated at higher application forces. Additionally, the inventors have appreciated that in some instances, cohesive forces between a label applicator pad and a label may cause the label to be pulled away from an article by the pad following the pressing of the label against the article. These cohesive forces may have numerous undesirable effects, such as misaligned labels, or incomplete and/or failed label application.

Aspects described herein provide a label applicator pad that is constructed and arranged to forcibly press a label against an article with higher forces compared to conventional applicator pad designs, while also improving the wear properties of the applicator pad. Aspects described herein also provide a label applicator pad that is constructed and arranged to reduce cohesion between the applicator pad and a label, thus allowing easy release of the label from the applicator pad.

In one embodiment, a label applicator pad includes a pad body having a contact portion with a working area on a first side. The working area is constructed and arranged to receive a label and forcibly press the label into contact with an article to which the label is applied. The label applicator pad further includes a support portion supporting the contact portion on a second side of the contact portion opposite the first side. The working area of the contact portion is textured to include a contact area arranged to physically contact a front side of the label when pressing the label into contact with the article, and to define a void portion adjacent the contact area arranged to be adjacent the front side of the label when pressing the label into contact with the article without physically contacting the label. The contact portion has a lower compliance than the support portion so as to deform less than the support portion upon application of pressure to the contact portion when pressing the label into contact with the article.

In another embodiment, a label applicator pad includes a contact portion having a working area having a total area and constructed and arranged to receive a label and forcibly press the label into contact with an article to which the label is applied. The working area comprises a contact area arranged to physically contact a front side of the label when pressing the label into contact with the article, and defines a void portion adjacent the contact area. The void portion is arranged to be adjacent the front side of the label when pressing the label into contact with the article without physically contacting the label. In one embodiment, the contact area is between 1% and 80% of the total area, and the void portion includes one or more void regions having a void region area of at least 4 square mm.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures and claims.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of one embodiment of a label applicator pad having a textured working area;

FIG. 2 is a perspective view of another embodiment of a label applicator pad having a textured working area;

FIG. 3 is a perspective view of yet another embodiment of a label applicator pad having a textured working area;

FIG. 4 is a schematic cross-sectional side view of one embodiment of a label applicator pad having a textured working area, further showing a label in contact with the label applicator pad;

FIG. 5 is a schematic cross-sectional side view of one embodiment of a label applicator pad having a unitary construction;

FIG. 6 is a schematic cross-sectional side view of yet another embodiment of a label applicator pad, showing cavities in the pad body;

FIG. 7 a schematic plan view of one embodiment of a label applicator pad including a plurality of discrete protrusions;

FIG. 8 is a schematic plan view of another embodiment of a label applicator pad including a plurality of void regions;

FIG. 9 is a schematic plan view of on embodiment of an automated labeling system;

FIG. 10 is a perspective view of the labeling system of Fig.9;

FIG. 11 is a perspective partial broken view of the labeling system of FIG. 9, illustrating an adhesive activation station;

FIG. 12 is a schematic cross-sectional view of a label; and

FIG. 13 is a perspective view of a label applicator pad including associated label retaining members.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. For example, aspects are described herein with reference to label applicator pads for use in automated labeling systems, and in particular, systems that utilize fluid activatable adhesives. However, aspects of the invention are not limited to the label applicator pad arrangements described herein, or to labeling systems utilizing fluid activatable adhesives. For example, the label applicator pads described herein may be suitable for use with labeling systems that use conventional tacky adhesives (e.g., cold glue and/or hot melt adhesives). Thus, aspects of the invention are not intended to be construed narrowly in view of the illustrative embodiments. In addition, it should be understood that aspects of the invention may be used alone or in any suitable combination with other aspects of the invention.

Label applicator pads as described herein may be used in a labeling system, such as an automated rotary bottle labeling system described in more detail below, to forcibly press a label against the surface of an article to adhere the label thereto. For example, a label applicator pad may have a working area, which may correspond to an outwardly facing front face of the pad that is adjacent a label during application. During a labeling operation, the working area may receive a front side of the label (i.e., the side of the label that is intended to face outwardly from the surface of the article after application of the label) such that a rear side of the label, which may include a suitable adhesive, may be exposed. Subsequently, the label applicator pad may apply a suitable application force to the label and the article in order to secure the label to the article.

As used herein, an application force generally refers to a force applied to a label by a label applicator pad when the label applicator pad forcibly presses the label against an article. In some instances, the application force may be distributed over a contact area of the label applicator pad, and accordingly, the applicator pad may apply an application pressure to the label to adhere the label to the article. Depending on the particular embodiment, a suitable application force or pressure may cause an adhesive on a label (e.g., an activated fluid activatable adhesive) to securely adhere the label to the article.

In some instances, an application force applied by a label applicator pad may depend on an overall compliance of the label applicator pad. For example, a labeling system may be configured such that a label applicator pad undergoes a predetermined amount of deformation when applying a label to an article, thus the compliance of the label applicator pad may determine the application force that results from the deformation. Accordingly, in some embodiments, a label applicator pad may be configured to have lower overall compliance compared to conventional applicator pads in order to apply larger application forces. As discussed above, these larger application forces may be advantageous in labeling systems that utilize fluid activatable adhesives, which may have a lower tackiness compared to conventional adhesives, in order to ensure that the label is securely applied to the article. Alternatively or additionally, a lower compliance may allow the label applicator pad to achieve a desired application force with a lower overall deformation, which may aid in reducing the wear-rate of the applicator pad. As discussed in more detail below, suitable materials for an applicator pad according to the current disclosure include, but are limited to, solid elastomers and/or rubbers, which have a lower compliance compared to foam materials used in conventional applicator pads.

In certain embodiments, a working area of a label applicator pad has a textured configuration such that only a portion of the working area (i.e., a contact area) contacts a label when the applicator pad presses the label against an article. Consequently, a contact area of the applicator pad that physically contacts the label is less than a total area of the working area, which may correspond to a projected area of a front face of the textured applicator pad. For example, the contact area may be less than 80% of the total area, less than 60% of the total area, less than 40% of the total area, less than 20% of the total area, less than 10% of the total area, less than 5% of the total area, greater than 1% of the total area, greater than 5% of the total area, greater than 10% of the total area, greater than 20% of the total area, greater than 40% of the total area, greater than 60% of the total area, or greater than 70% of the total area. Combinations of the above noted ranges are also contemplated. For example, the contact area may be between about 1% and about 80% of the total area, between about 10% and 60% of the total area, between about 20% and 50% of the total area, and so on. Without wishing to be bound by any particular theory, in some cases, the smaller contact area may concentrate an application force applied by a label applicator pad, thereby resulting in larger forces and/or pressures being applied to the label by the applicator pad compared to a non-textured pad.

According to some aspects, a textured working area may aid in reducing cohesive forces between a label and an applicator pad. For example, a smaller contact area between the applicator pad and the label may directly reduce such cohesive forces by limiting the area in which the cohesive forces may act. Additionally, a textured configuration may define one or more void regions on the front face in which the applicator pad does not contact the label when pressing the label against an article. These void regions may further aid in reducing cohesion by reducing the presence of fluid on the front face of the applicator pad. Without wishing to be bound by any particular theory, contact between fluid (e.g., activating fluid used to activate a fluid activatable adhesive) on the contact area of the applicator pad and a label may tend to promote cohesion between the label and the applicator pad via capillary or other effects. Accordingly, the void regions may receive excess fluid and, in some instances, the void regions may be constructed and arranged to provide one or more flow channels to direct the excess fluid away from the label and off of the label applicator pad. Accordingly the void regions may aid in reducing the total area of contact between the fluid and the label. In some embodiments, each void region may have a void region area of at least 4 square mm, at least 6 square mm, at least 8 square mm, at least 10 square mm, or larger.

In some embodiments an applicator pad may include a pad body having a contact portion having a working area, such as a textured front face, on a first side of the contact portion. As noted above, the working area may be constructed and arranged to receive a label and forcibly press the label into contact with an article to which the label is applied. The pad body may further include a support portion that supports the contact portion on a second side of the contact portion, opposite the first side. In certain embodiments, the contact portion and support portion may be formed as a unitary structure, with the contact portion defining a layer of the pad body arranged to be adjacent a label when applying the label and the support portion defining the remainder of the pad body. For example, in at least one embodiment, the contact portion is a thin layer forming a distal face of the applicator pad, and the support portion is defined by the remainder of the pad body proximal to the contact portion. In other embodiments, the contact portion and support portion may be formed as separate components (which in at some cases may be formed from different materials) and may be attached to one another in any suitable manner.

In certain embodiments, the contact portion of a pad body may be configured to have a lower compliance than a support portion forming the remainder pad body. For example, the support portion may include a compliant foam material, and the contact portion may include a stiffer and more robust material such as a solid (i.e., non-porous) elastomer or rubber. In other embodiments, the contact portion and support portion may be formed from the same material, but the support portion may include one or more structural features (discussed in more detail below) that result in the support portion exhibiting a higher overall compliance than the contact portion.

According to some aspects, a lower compliance of the contact portion of an applicator pad (e.g., a face of the applicator pad that is arranged to contact a label) may aid in maintaining a textured configuration of the front face as the applicator pad presses the label against the article, thereby maintaining one or more of the above-noted advantages that the textured configuration may provide, such as increased application forces and/or reduced cohesion between the applicator pad and a the label. For example, in some embodiments, the application force for applying a label to an article may be between about 3 pounds and about 8 pounds, and the compliance of the contact portion may be chosen such that an overall deformation of the contact portion is less than 1 mm. Additionally, the compliance of the support portion may be chosen such that a deformation of the support portion is between about 3 mm and about 20 mm when applying the label. In some cases, the compliance of the contact portion may be less than about 50% of the compliance of the support portion, less than about 25% of the compliance of the support portion, less than 10% of the compliance of the support portion, less than 5% of the compliance of the support portion, or smaller. For example, in some embodiments, the relative compliances of the contact portion and support portion may be chosen such that the contact portion accounts about 5% of the total deformation of the applicator pad, while the support portion accounts for about 95% of the deformation. In some instances, the compliance of the support portion may be chosen such that the applicator pad may undergo a suitable amount of deformation when applying the label to an article. This deformation may allow the applicator pad to at least partially conform to the article, thereby providing a more uniform application force to the label. The compliance of the support portion also may be chosen to provide a desired application force when the applicator pad deforms against the article, as discussed above.

Depending on the particular embodiment, a textured working area of a label applicator pad may be defined by any suitable combination of features formed on a contact portion of the applicator pad. For example, in some embodiments, a label applicator pad may include one or more protrusions extending outwardly from the contact portion to form a contact area, and the protrusions may have any suitable shape and/or configuration. For instance, protrusions may include one or more ribs extending across the contact portion to define at least a portion of the contact area, or alternatively, the protrusions may be formed as discrete, raised mesas having any suitable shape. In certain embodiments, the protrusions may have substantially flat surface to contact a label, though in other embodiments, the protrusions may have a rounded surface or may have a pointed configuration. Alternatively, the contact portion may include void regions in the form of one or more depressions such as trenches or dimples that define a textured working area. Accordingly, it should be understood that current disclosure is not limited to any particular configuration and/or combination of features that define a textured working area of a label applicator pad.

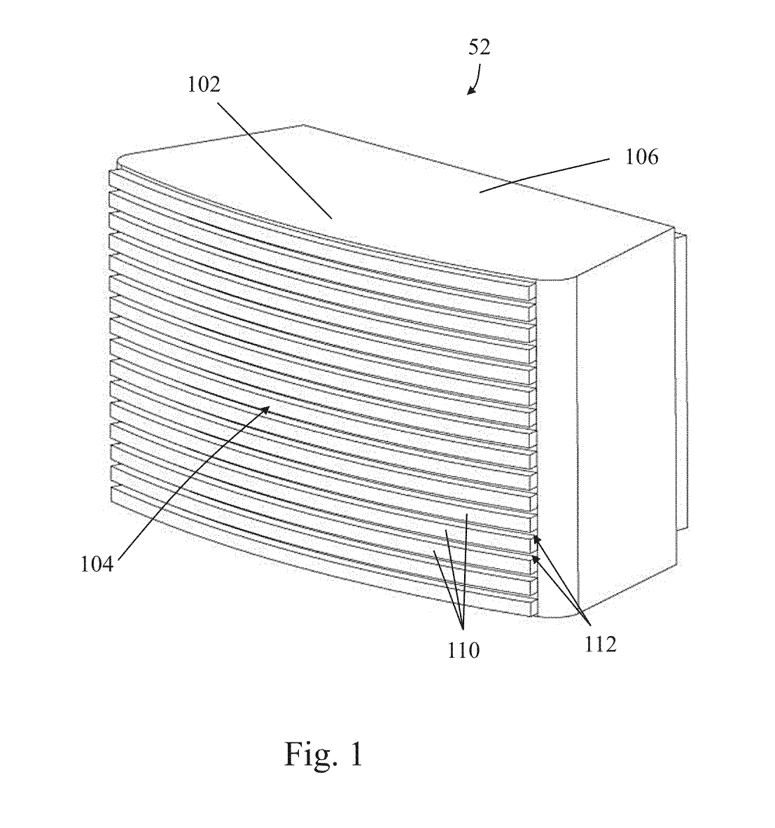

FIG. 1 shows a perspective view of one illustrative embodiment of a label applicator pad 52. The applicator pad includes contact portion 102 adjacent a front surface of the applicator pad, a working area 104 to receive a label, and a support portion 106. In this embodiment, the working area includes a contact area defined by a plurality of protrusions 110, which in this particular embodiment have the form of ribs extending across the contact portion, though other protrusion shapes are also contemplated, as discussed in more detail below. The protrusions 110 are separated by void regions 112, which are formed as channels between the ribs and together form a void portion; for clarity, only three protrusions and two void regions are labeled in FIG. 1. In the depicted embodiment, the protrusions 110 (i.e., ribs) are generally rectangular and form a substantially flat contact area that contacts a label when the label is received on the working area. The void regions 112 between the protrusions 110 define a void portion of the working area in which the applicator pad does not physically contact a label.

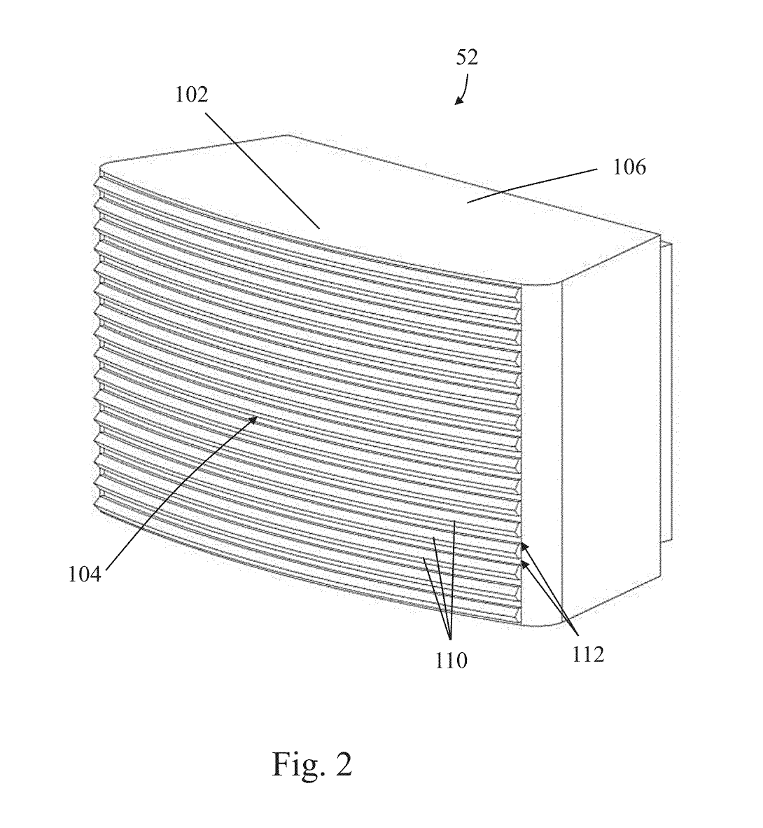

FIG. 2 shows a perspective view of another illustrative embodiment of a label applicator pad 52. Similar to the embodiment shown in FIG. 1, the label applicator pad includes a contact portion 102, a working area 104 to receive a label, a support portion 106, and a plurality of protrusions 110 separated by void regions 112. In this embodiment, however, the protrusions 110 are formed as ribs extending across the contact portion and having a generally triangular cross-sectional shape such that a contact area of the protrusions that contacts a label is limited to the pointed portion at a distal end of the ribs, which may be a small percentage (e.g., 1-10%) of the total area of the working area 104. Additionally, the pointed configuration may aid in concentrating an application force when the applicator pad presses the label against an article. Similar to the embodiment shown in FIG. 1, the void regions 112 are formed as channels between the protrusions 110 and define a void portion of the working area in which the applicator pad does not physically contact a label.

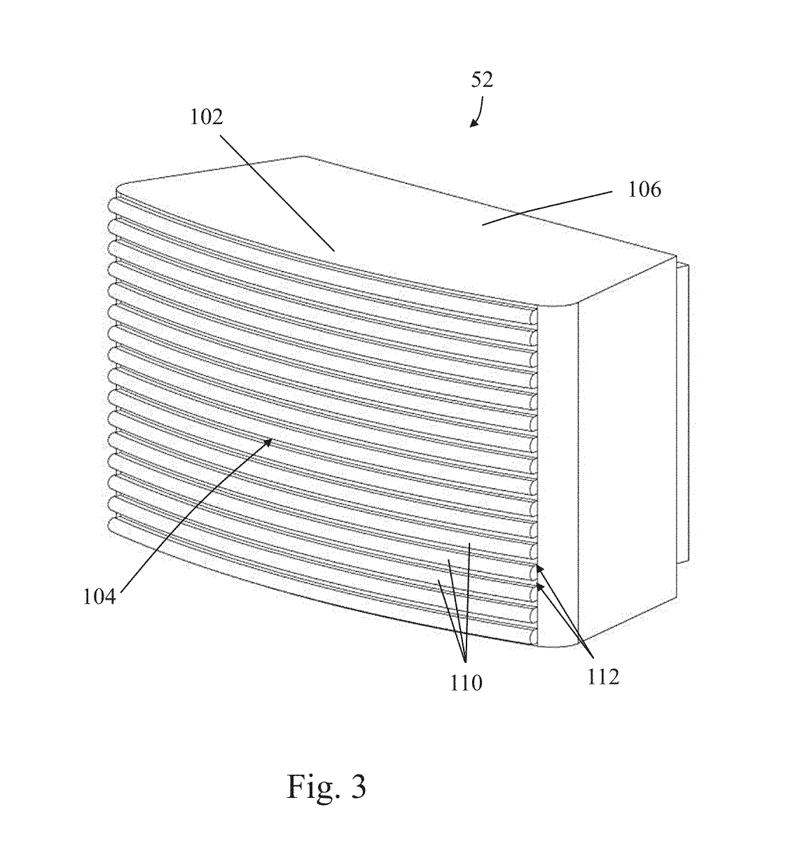

FIG. 3 shows a perspective view of yet another illustrative embodiment of a label applicator pad 52. Similar to the embodiments shown in FIGS. 1-2, the label applicator pad includes a contact portion 102, a working area 104 to receive a label, a support portion 106, and a plurality of protrusions 110 in the form of ribs separated by void regions 112 in the form of channels between the ribs. In this embodiment, the protrusions 110 have a generally rounded shape at a distal end that contacts a label.

Although each of FIGS. 1-3 depict a label applicator pad in which protrusions are formed as parallel ribs extending horizontally across the working area, it should be understood that other arrangements are also contemplated. For example, in other embodiments in which protrusions are formed as ribs, the ribs may be oriented in any direction across the contact area, such as horizontally, vertically, or diagonally at any suitable angle. In some instances, the ribs may be substantially linear and parallel to one another (such as the ribs depicted in FIGS. 1-3). Alternatively, ribs may be formed with zig-zag patterns, wavy patterns, irregular serpentine patterns, or any other suitable arrangement. Further, although the ribs are depicted as having substantially the same size, shape, and spacing, it should be understood that other configurations also may be suitable. For example, the ribs may be non-uniformly spaced, and the size of the ribs may be different in different sections of the contact portion. Moreover, in some instances, the ribs may not extend entirely across the contact portion. For example, multiple rib segments may extend across portions of the contact portion and may be separated by intermittent spaces which connect adjacent void regions in the working area (e.g., channels between adjacent ribs). Accordingly, it should be understood that the current disclosure is not limited to any particular configuration of ribs or similar protrusions defining a textured working area.

As noted above, in some instances, void regions of an applicator pad may be arranged to receive and direct fluid (e.g., excess activating fluid) away from the contact area. For instance, in one embodiment including one or more ribs, the channels between ribs may direct fluid away from the contact area and towards edges of the applicator pad. In this manner, the channels may further aid in reducing cohesion between the applicator pad and a label by reducing unintended contact between fluid on the applicator pad and the label.

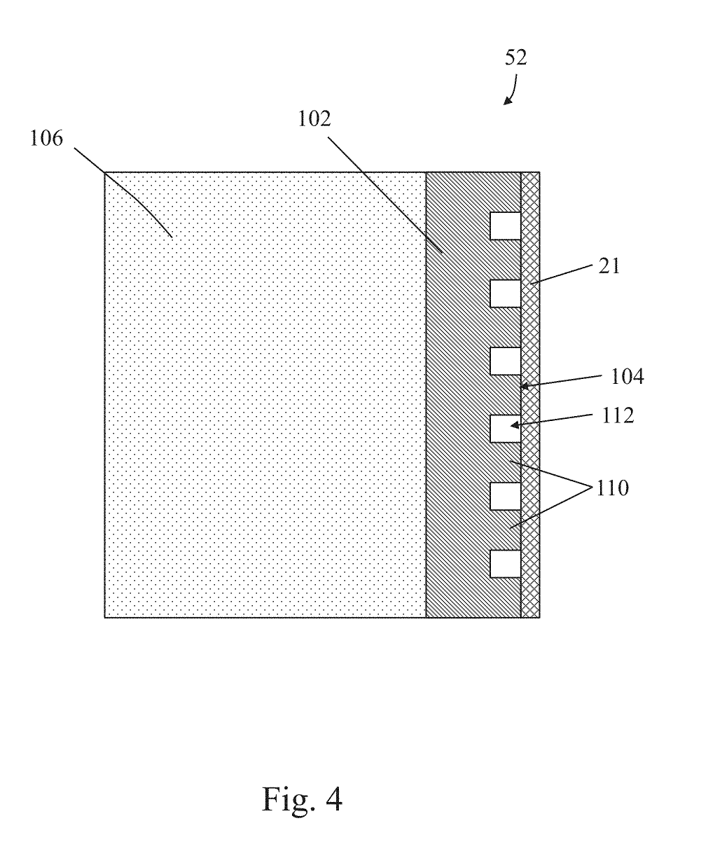

FIG. 4 is a schematic cross-sectional side view of one embodiment of a ribbed applicator pad 52, similar to the embodiment shown in FIG. 1. The applicator pad includes a contact portion 102 that includes a textured working area 104 comprising a plurality of protrusions 110 separated by void regions 112. A label 21 is received on the working area and contacts the ribs 110, while not contacting the contact portion in areas corresponding to the void regions 112. In this manner, the protrusions 110 define a contact area that is less than a total area of the working area, and the void regions 112 define a void portion of the working area where the applicator pad does not physically contact the label 21.

As illustrated in FIG. 4, the contact portion 102 and its protrusions 110 are formed as a unitary structure and may be separately formed from the support portion 106. The contact portion 102 may be formed from a material having a lower compliance than a material of the pad body 106; for example the contact portion 102 may be formed from a solid rubber or elastomeric material, while the support portion 106 may be formed from a more compliant foam. As discussed above, such a configuration may be advantageous to provide an applicator pad which may at least partially conform to the surface of an article when applying a label, but which also maintains a textured configuration within the working area. In particular, the lower compliance of the contact portion may limit the deformation within the contact portion such that the textured configuration is maintained during application of the label 21.

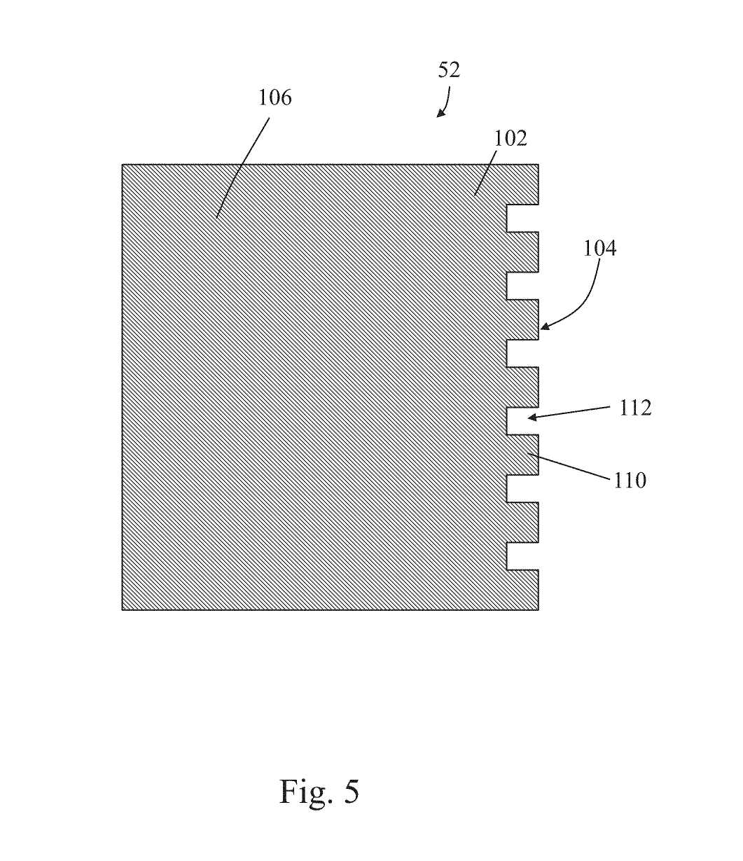

FIG. 5 depicts a schematic cross-sectional side view of another illustrative embodiment of an applicator pad 52. In this embodiment, the applicator pad includes a contact portion 102 and a support portion 106 that are formed as a single unitary body. Similar to the embodiment described above, the contact portion includes a textured working area 104, which includes rectangular protrusions 110 separated by void regions 112. In some instances, such a unitary construction may offer numerous advantages, such as simplifying the manufacturing of the applicator pad, providing an applicator pad with a lower compliance such that it is capable of applying higher forces to a label, providing an applicator pad with a higher resistance to wear, and so on.

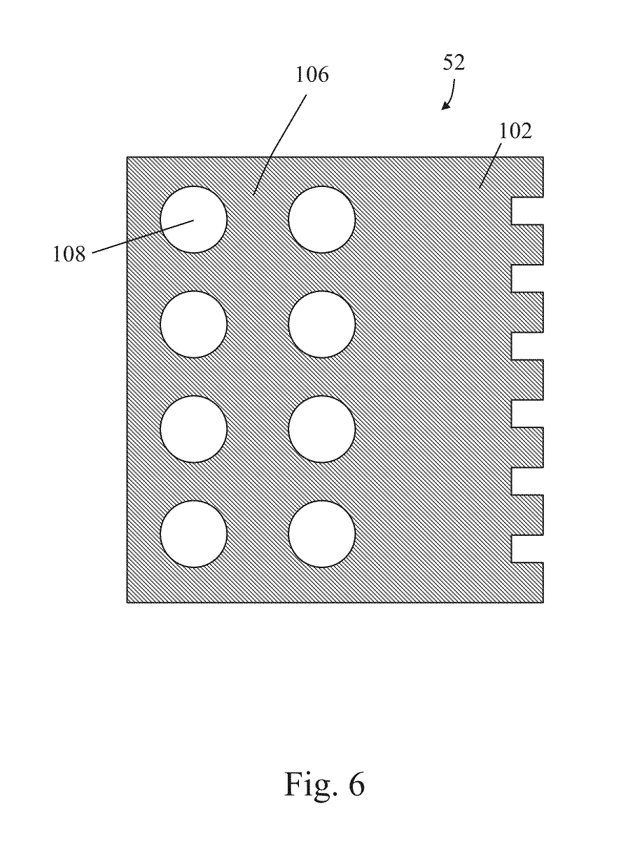

FIG. 6 depicts yet another embodiment of an applicator pad 52. Similar to the embodiment depicted in FIG. 5, the contact portion 102, and support portion 106 are formed as a single, unitary structure. However, in the depicted embodiment, the support portion includes a plurality of cavities 108 which may allow for modulation of the overall compliance of the support portion. In particular, the cavities correspond to regions where material has been removed from the support portion, and thus the cavities generally result in an increase in the compliance of the support. Accordingly, by controlling the shape, size, and/or distribution of the cavities 108, the compliance of the support portion 106 can be tuned for a particular labeling application. In some cases, different sections of a support portion may have a different configuration of cavities such that the different sections have a different compliance. For example, it may be desirable for the forces applied to the center of a label to be greater than those applied to the edges of the label. Thus the cavities 108 may be sized, shaped, and/or positioned to provide a lower compliance in the middle of the support portion and a higher compliance at the edges of the support portion. Alternately, or in addition, the cavities 108 may be filled partially or completely with a material, such as a foam rubber or other, to provide a desired compliance.

Although a support portion including a plurality of cavities to control the compliance is described above with reference to an applicator pad having a unitary construction, it should be understood that other configurations are also contemplated. For example, one or more cavities may be included in the support portion of the applicator pad depicted in FIG. 4 to allow for fine tuning of the support portion compliance. In some cases, the size, shape and/or location of cavities may be controlled to provide desired variability in compliance across the working area of the pad. For example, in some cases a pad may provide a lower compliance near a center of the working area and higher compliance near edges of the working area. Accordingly, it should be understood that the current disclosure is not limited to any particular configuration of cavities included in the support portion.

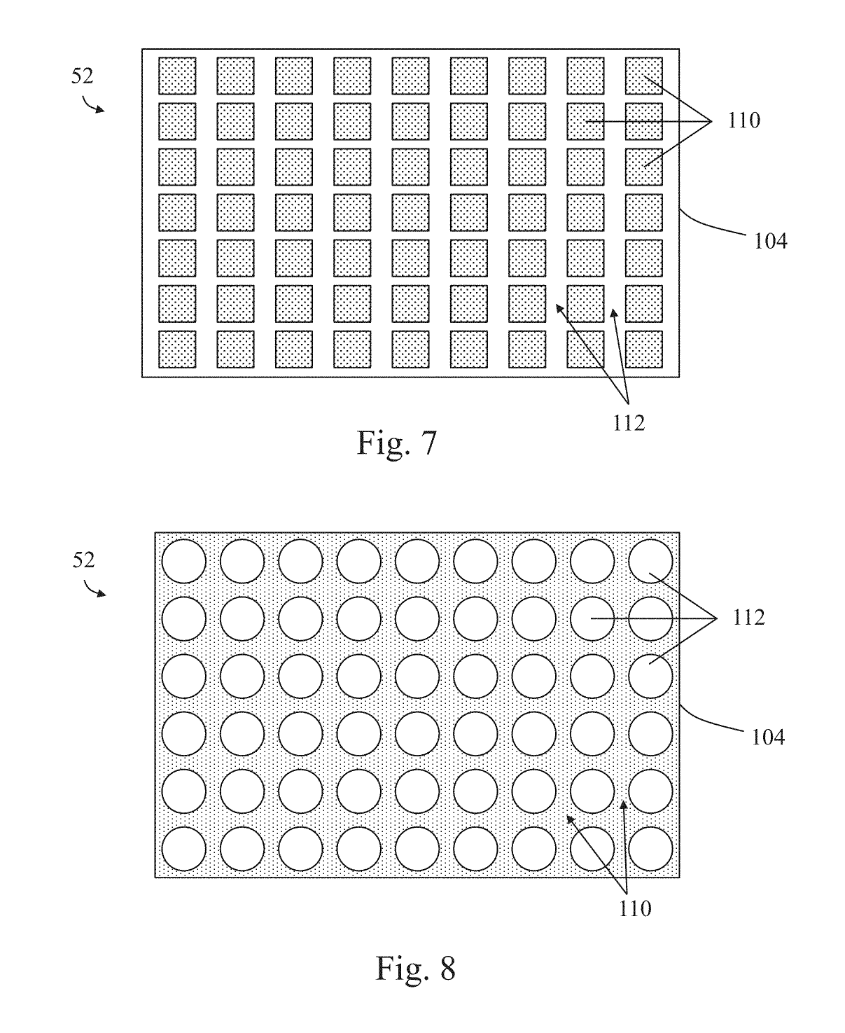

Further, although FIGS. 1-6 depict applicator pads including protrusions in the form of ribs and void regions formed as channels between the ribs that define a textured working area, other textured configurations are also contemplated. For example, FIGS. 7 and 8 depict illustrative embodiments of applicator pads that do not include ribs.

In particular, FIG. 7 depicts a schematic plan view of an illustrative embodiment of an applicator pad 52 including a plurality of discrete protrusions 110 in the form of mesas extending outwardly in the working area 104. In this manner, the mesas define a contact area (the shaded regions in FIG. 7) in which the applicator pad physically contacts a label, and the void regions 112 between the protrusions define a void portion of the working area in which the applicator pad does not contact the label.

In contrast, FIG. 8 shows a schematic plan view of another embodiment of an applicator pad 52 that includes a plurality of void regions 112 extending inwardly into the working area 104, thereby defining a void portion of the working area where the applicator pad does not contact a label. Accordingly, the void regions define protrusions 110 in the areas between the void regions, and the protrusions have a contact area (shaded region) that physically contacts a label.

In FIG. 7, the protrusions 110 are shaped as squares, and in FIG. 8, the void regions 112 are shaped as circles. However, it should be understood that these features may have any suitable shape, including, but not limited to squares, circles, ovals, stars, triangles, rectangles, irregular curved shapes, irregular polygons, and so on. Further, although each of the projections 110 and void regions 112 are depicted as having substantially the same size and being uniformly distributed, other configurations are also contemplated. For example, the size, shape, spacing, distribution, etc. of the projections and/or depressions may be different in different sections of the working area. In some instances, a specific configuration may be chosen to provide a desired application force to different portions of a label, and/or to provide a desired reduction in cohesion between a label and the applicator pad in different regions of the applicator pad. Further, in some embodiments, such as that shown in FIG. 8, one or more void regions in the working area may define irregularly shaped protrusions in the areas between the void regions, and at least a portion of the protrusions may be connected to form a continuous contact area within the working area. Accordingly, it should be understood that the current disclosure is not limited to any particular combination of protrusions and/or void regions that define a textured working area of an applicator pad.

The applicator pads depicted in FIGS. 1-3 and 7-8 have a generally rectangular working area, though it should be understood that an applicator pad may have any suitable shape, as the current disclosure is not limited in this regard. Further, as best illustrated in FIGS. 1-3, the working area may have a convex curvature, though applicator pads with a concave curvature, no curvature (i.e., a flat front surface), or applicator pads having a different curvature in different portions are also contemplated. In certain embodiments, the working area of an applicator pad may be between about 2500 mm² and about 7000 mm², and a force applied to a label by the applicator pad may be between about 3 pounds and about 8 pounds. Further, as discussed above, each of the features that define a textured configuration of a working area of an applicator pad (e.g., ribs, protrusions, void regions, etc.) may have any suitable size and/or shape. In one example, ribs, such as the generally rectangular ribs depicted in Fig.1, may have a width of about 0.7 mm, a height of about 1 mm, and a spacing between adjacent ribs may be at least about 2.5 mm. As another example, protrusions such as those depicted in FIG. 7, may have a size (e.g., a width) of between about 0.5 mm and 2 mm, a height of about 1 mm, and a spacing between adjacent protrusions may be at least 1 mm. Depending on the particular embodiment, each void region may have an area defined by a projected area of the void region within the working area of the applicator pad. In some cases, such as in the embodiment shown in FIG. 8, one or more void regions may be interconnected. In such embodiments, the void region area may be defined as the area between adjacent protrusions. As noted above, the void region area may be greater than 4 square mm, greater than 8 square mm, greater than 10 square mm, and so on.

The various aspects of an applicator pad may be formed using any suitable manufacturing method. For example, one or more features defining a textured configuration in a working area may be molded with a contact portion, which may be subsequently attached to a pad body. Alternatively, in embodiments featuring a unitary configuration, the entire applicator pad may be molded together. In further embodiments, discrete features such as ribs, protrusions, etc. may be attached to the surface of an applicator pad using a suitable adhesive or bonding method.

Suitable materials for applicator pads according to the current disclosure include, but are not limited to polymeric materials such as solid elastomers such as silicones, polyurethanes, and natural and synthetic rubbers, or flexible thermoplastic materials. As discussed above, such materials may provide an applicator pad with a lower compliance compared to the compliant foam materials used in conventional applicator designs. Additionally, these materials may be less susceptible to breakdown than conventional foams when used to apply high application forces, and thus the applicator pads described herein may exhibit improved wear resistance and longer usable lifetimes compared to conventional applicator pads. Depending on the particular embodiment, a contact portion of an applicator pad may be made from a material having any suitable durometer. For example, in some embodiments, the contact portion may be made from a material having a durometer of between about 10 Shore A and about 80 Shore A.

In some instances, an activating fluid used to activate a fluid activatable adhesive from a non-tacky state to a tacky state may include one or more solvents that may cause deterioration of the foams used in conventional applicator pads. In particular, the foam materials are liquid permeable and may allow ingress of the solvents into the pad body where the solvents may break down the foam material. In contrast, the solid elastomer and rubber materials described above may be liquid impermeable and may thus exhibit superior resistance to these solvents, thereby further improving the wear life of the applicator pads compared to conventional designs.

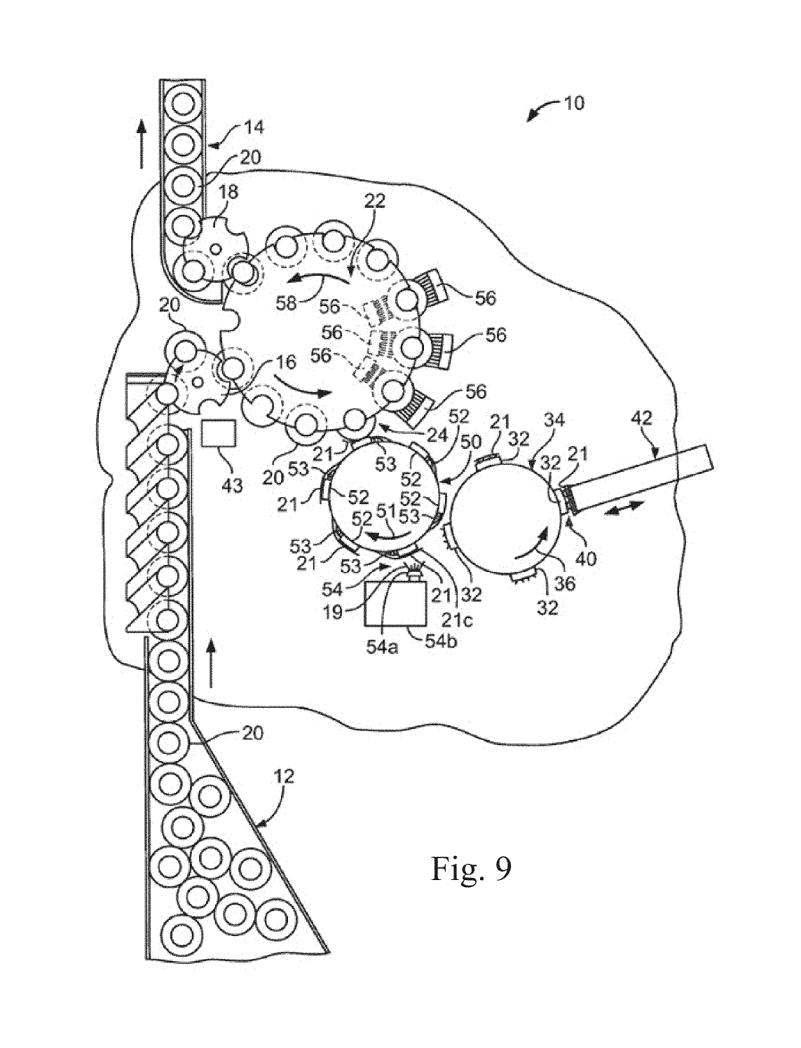

Having described various illustrative embodiments of label applicator pads, an automated labeling system, which may incorporate one or more of the label applicator pads described herein, is described below with reference to FIGS. 9-13. In particular, the system described below may be used to automatically apply labels having a fluid activatable adhesive to containers such as bottles.

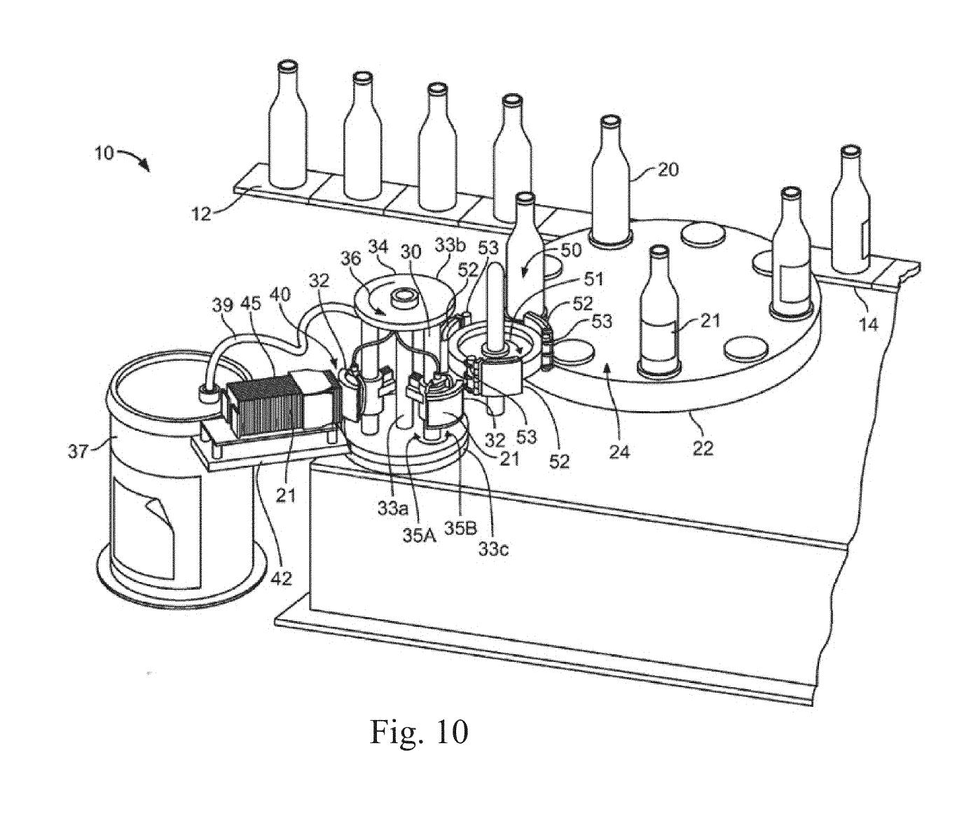

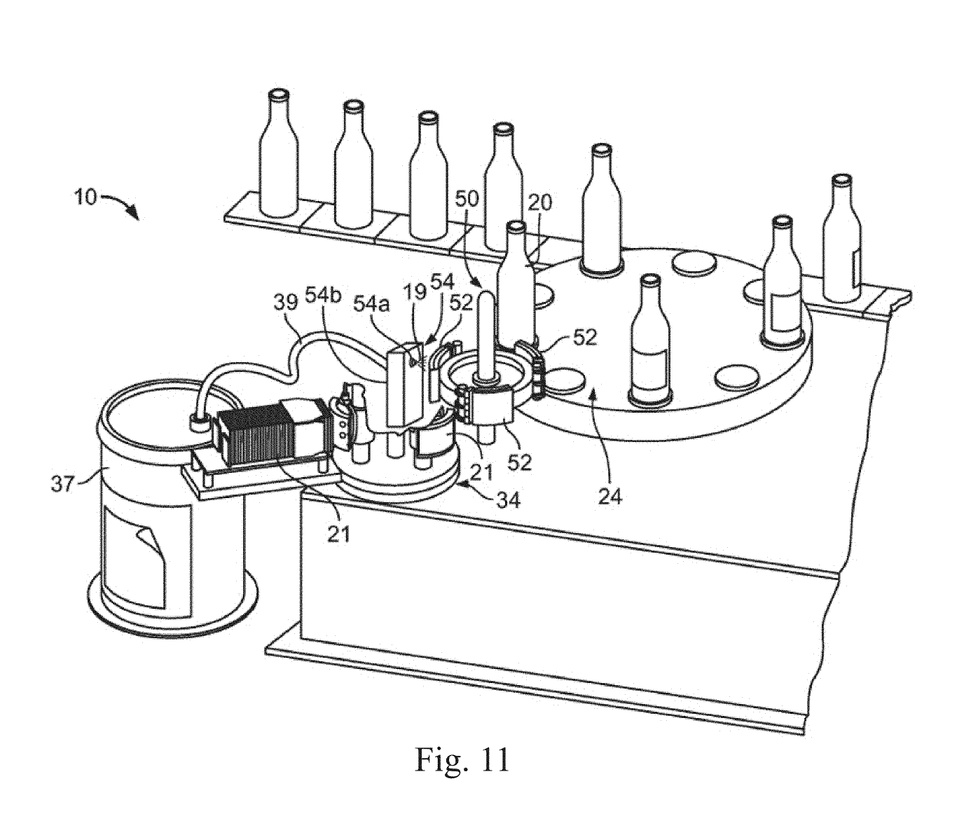

As shown in FIGS. 9-11, labeling system 10 employs an inlet conveyor section 12, an outlet conveyor section 14 and rotating bottle-transfer members 16 and 18 for transferring bottles 20 from the inlet conveyor section to a rotating platform or turret 22, and for removing bottles 20 from the rotating turret 22 to the exit conveyor section 14, respectively, after the bottles have been directed through label application station 24. However, in some embodiments an in-line system that does not require the use of a rotating turret to handle the bottles, or other containers, during the label application operation can be used. Bottle-transfer members 16 and 18 are not shown in FIGS. 10 and 11 for purposes of illustration.

It should be understood that the construction of the inlet conveyor section 12, outlet conveyor section 14, rotating bottle-transfer members 16 and 18 and rotating turret 22 would be apparent to one of ordinary skill in the art. For example, Krones manufactures a line of rotary labeling equipment including an inlet conveyor section 12, an outlet conveyor section 14, rotating bottle-transfer members 16 and 18 and a rotating turret 22 of the type that can be employed in the present systems and methods. Therefore, a detailed discussion of these features is not required herein.

The labeling system 10 also includes two transfer members 34 and 50 that are used to transfer a label from a magazine 42 that retains a stack 45 of labels to the bottles 20. During operation, the first rotating transfer member 34 uses a suction-based pallet to remove a non-activated label (i.e., a label having a fluid activatable adhesive that has not been exposed to an activating fluid) from the magazine 42 and transfer the label to a pallet on the second rotating member 50. Once the label is secured on the second rotating member, the vacuum is released. Subsequently, an activating fluid is applied by an adhesive activation station 54 and the activated label is subsequently applied to the bottle. Multiple pallets 32 are mounted on the first rotating transfer member 34 (rotated in the direction of arrow 36) through support shafts 30, and are mounted for oscillatory motion relative to the support shaft, as represented by the arrow heads 35 and 35A. The oscillatory motion is provided by a cam drive arrangement. Exemplary cam drive arrangements for rotating a transfer member are known to those skilled in the art. Transfer member 34 rotates along a shaft 33a which extends between a pair mounting plates 33b and 33c.

As best illustrated in FIG. 10, pallets 32 are oscillated in the counterclockwise direction of arrow 35A, and are directed sequentially by the rotating member 34 to a transfer station 40. The transfer station 40 includes a magazine 42 retaining a stack 45 of cut labels 21 therein. A label is transferred from the transfer station 40 by application of a vacuum to the pallet 32. The label continues to be retained on the pallet 32 during rotation of the transfer member 34 by continued application of the vacuum.

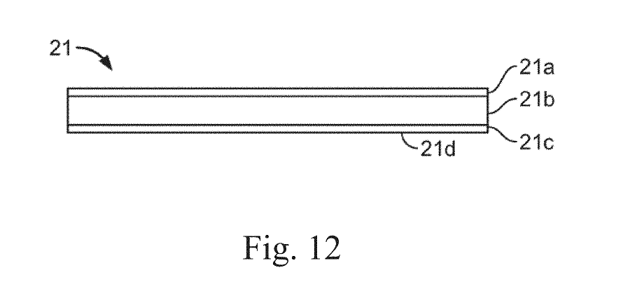

As shown in FIG. 12, each label 21 has a printable layer 21a formed on the front side of a stock, media, or facesheet 21b, and a back side 21c with a solvent (fluid) sensitive adhesive agent layer 21d (i.e., a fluid activatable adhesive, such as a polymer type adhesive) which possesses no tack in its dry or non-activated state. Layer 21d enables label 21 to become tacky along its back side once layer 21d becomes tacky upon application of activating fluid 19 when supplied at adhesive activation station 54, as described later below. This enables the label, once its adhesive is activated, to adhere along its back surface to a variety of article surfaces, such as paper, cardboard, metal, as well as glass and plastics. In the example of FIGS. 9-11, the containers 20 may be glass or plastic bottles. Exemplary labels 21 and activating fluid 19 are described in U.S. Pat. No. 8,334,336 titled “Fluid Activatable Adhesives and Fluids for Activating Same for Use with Liner-Free Labels” and U.S. Pat. No. 8,334,335 titled “Fluid Activatable Adhesives and Fluids for Activating Same for Use with Liner-Free Labels”, the contents of each of which are hereby incorporated by reference in their entirety. The printable layer 21a may be a preprinted layer of ink(s) providing the desired label for container 20 as is typical of labels applied to containers. Typically all labels in the stack 45 are identical for a given set of containers 20 being processed by the labeling system 10.

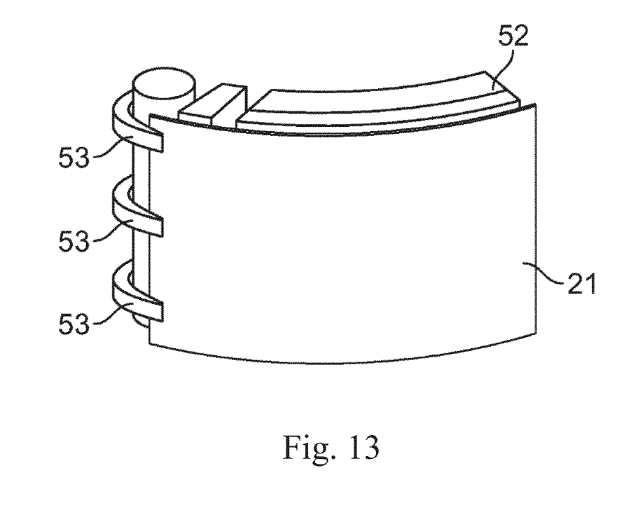

Referring again to FIGS. 9-11, pallets 32 receive labels 21 from the magazine 42, and subsequently, the pallets 32 with the labels 21 thereon are rotated by the support member 34 to a second rotating transfer member 50 (rotated in the direction of arrow 51) having a plurality of label applicator pads 52, each having cam operated label retaining (or gripping) members or fingers 53 disposed about the periphery thereof for engaging labels 21 carried by the transfer pallets 32 and transferring the labels to the second rotating transfer member 50. As shown in FIG. 13, each of the retaining members 53 grip the label 21 to retain the label on the associated label applicator pad 52. When the label is applied to a bottle at the label application station 24, the retaining members 53 are moved to release the labels.

The second rotary transfer member 50, with labels 21 thereon, is directed through an adhesive activation station 54 to change the a fluid activatable adhesive layer 21d to a tacky state to permit the label to be securely and effectively adhered to the outer surface of a container 20 along its back surface 21c. As shown in FIGS. 9 and 11, adhesive activation station 54 has one or more fluid dispensing mechanisms (e.g., such as a sprayer 54a) for application of pressurized adhesive activation fluid 19 onto labels 21. The activation fluid can be a combination of one or more solvents, such as water and/or low boiling point alcohols. In some examples, the activation fluid does not contain any suspended or dissolved solids in the liquid (e.g., the fluid is a blend of one or more neat drying solvents and/or water) and only contains solvents. In some examples, the solvents can have low enough vapor pressures to evaporate in room temperature environmental conditions. By including no suspended solids in the activation fluid and utilizing volatile solvents, any liquid that is released and not applied to the labels (overspray) will dry clean thereby reducing cleanup and maintenance of the system 10. Each of the one or more sprayers 54a may be a nozzle with a valve that is held in a fixture 54b (depicted schematically as a block in FIGS. 9 and 11). Each nozzle receives fluid 19, via a tube 39, from a source of such fluid, as depicted by container 37 in FIGS. 10 and 11. The nozzle's valve is actuated when needed to apply fluid 19 to wet label 21 as it moves through station 54. The timing of spraying of fluid 19 for different run speeds of the labeling system 10 is enabled by a suitable control system (not depicted). For example, the nozzle of each of the one or more sprayers 54 a may be an air-assisted nozzle. However, any sprayer mechanism may be used may be used so that adequate fluid 19 is sprayed on layer 21 as moves with respect to the station 54. For example, the fluid dispensing mechanisms can include an array of one or multiple fan or cone nozzles controlled by valves, an array of one or multiple air-assisted fan or cone nozzles controlled by valves, and/or an inkjet-type spray head.

In this manner, the second rotating transfer member 50 directs the labels held upon pads 52 through an adhesive activation station 54 to apply a fluid 19 for activating the fluid activatable adhesive on the label's back surface 21c to change its layer 21d from a non-tacky state to a tacky state just prior to application of the label to a container at label application station 24. For example, the fluid activatable adhesive is only tacky to permit the label to be adhered to the outer surface of a container at a location closely adjacent the label application station 24.

Once a label 21 is rotated to the label application station 24, the label is forcibly pressed against the surface of a bottle 22 by the label applicator pad 52 in order to adhere the label to the bottle. Subsequently, the rotating turret 22 directs each bottle, with the label attached thereto, through a series of opposed inner and outer brushes 56. As the bottles are directed through the series of brushes the bottles are also oscillated back and forth about their central axis to thereby creating an interaction between the bottles, labels and brushes to ensure that the entire label is adhered and secured to the bottle. This brush arrangement and the system for oscillating the bottles as they move past the brushes are of a conventional design and are well known to those skilled in the art. Such a system is included in labeling equipment employing cold glue, for example labeling equipment manufactured by Krones. After application of the labels, the bottles are carried by the rotating turret 22 in the direction of arrow 58 to the bottle-transfer member 18, at which point the bottles are transferred to the outlet conveyor section 14 for subsequent packaging

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A label applicator pad comprising:
a pad body having a contact portion with a working area on a first side constructed and arranged to receive a label and forcibly press the label into contact with an article to which the label is applied, and a support portion supporting the contact portion on a second side of the contact portion opposite the first side, the working area of the contact portion being textured to include a contact area arranged to physically contact a front side of the label when pressing the label into contact with the article, and defining a void portion adjacent the contact area arranged to be adjacent the front side of the label when pressing the label into contact with the article without physically contacting the label,
wherein the contact portion has a lower compliance than the support portion so as to deform less than the support portion upon application of pressure to the contact portion when pressing the label into contact with the article.

2. The label applicator pad of claim 1, wherein the contact portion includes one or more protrusions extending outwardly from the first side of the contact portion.

3-10. (canceled)

11. The label applicator pad of claim 2, wherein the one or more protrusions are configured to provide a stress concentration when pressing the label into contact with the article.

12. (canceled)

13. The label applicator pad of claim 1, wherein the contact portion is constructed and arranged to reduce cohesion between the label applicator pad and the label.

14-18. (canceled)

19. The label applicator pad of claim 1, wherein a material of the pad body is different than a material of the contact portion.

20. The label applicator pad of claim 1, wherein the pad body includes one or more cavities.

21. The label applicator pad of claim 1, wherein the pad body and contact portion are constructed and arranged so that the contact area does not increase when pressing the label into contact with the article.

22. (canceled)

23. A label applicator pad comprising:
a contact portion having a working area having a total area and constructed and arranged to receive a label and forcibly press the label into contact with an article to which the label is applied, the working area comprising a contact area arranged to physically contact a front side of the label when pressing the label into contact with the article, and defining a void portion adjacent the contact area arranged to be adjacent the front side of the label when pressing the label into contact with the article without physically contacting the label,
wherein the contact area is between 1% and 80% of the total area, and wherein the void portion includes one or more void regions having a void region area of at least 4 square mm.

24-25. (canceled)

26. The label applicator pad of claim 23, wherein the contact portion includes one or more protrusions extending outwardly from a first side of the contact portion.

27. The label applicator pad of claim 26, wherein the one or more protrusions are arranged to form one or more ribs, each rib extending across at least a portion of the contact portion.

28. The label applicator pad of claim 27, wherein each rib of the one or more ribs extends from a first edge of the contact portion to a second opposing edge of the contact portion.

29. (canceled)

30. The label applicator pad of claim 26, wherein each protrusion of the one or more protrusions has a cross-sectional shape that is at least one of a rectangle, an ellipse, a triangle, a regular polygon, an irregular polygon, and an irregular curved shape.

31. The label applicator pad of claim 26, wherein a spacing between adjacent protrusions is at least 1 mm.

32. The label applicator pad of claim 26, wherein each protrusion of the one or more protrusions has at least one of a flat surface, a rounded surface, or a pointed configuration.

33. The label applicator pad of claim 26, wherein the protrusions are uniformly distributed within the working area.

34. The label applicator pad of claim 26, wherein the protrusions are molded with the contact portion.

35. (canceled)

36. The label applicator pad of claim 23, wherein the contact portion includes one or more depressions extending inwardly into the first side of the contact portion.

37. (canceled)

38. The label applicator pad of claim 23, wherein the void portion is constructed and arranged to receive fluid.

39. The label applicator pad of claim 38, wherein the void portion provides at least one flow channel for the fluid.

40. The label applicator pad of claim 23, wherein a material of the contact portion comprises least one of an elastomer, a flexible thermoplastic material, a natural rubber, and a synthetic rubber.

41-46. (canceled)
